(19) United States
(12) Patent Application Publication
(10) Pub. No.: US 2020/0312556 A1
(43) Pub. Date: Oct. 1, 2020

(54) CERAMIC POWDER, DIELECTRIC CERAMIC, AND ELECTRONIC COMPONENT

(71) Applicant: Murata Manufacturing Co., Ltd., Nagaokakyo-shi (JP)

(72) Inventors: Yuka Mataba, Nagaokakyo-shi (JP); Hiroyuki Harano, Nagaokakyo-shi (JP); Daiki Habu, Nagaokakyo-shi (JP)

(21) Appl. No.: 16/878,930

(22) Filed: May 20, 2020

Related U.S. Application Data
(63) Continuation of application No. PCT/JP2018/002002, filed on Jan. 23, 2018.
Application No. PCT/JP2018/002002 is a continuation of application No. PCT/JP2019/001779, filed on Jan. 22, 2019.

(30) Foreign Application Priority Data
Jan. 23, 2018 (JP) PCT/JP2018/002002

(51) Int. Cl. H01G 4/12; H01G 4/30; C04B 35/491

(52) U.S. Cl. CPC H01G 4/1245; C04B 35/491; H01G 4/30

(57) ABSTRACT

A ceramic powder that contains 39.9 mol % to 47.0 mol % of Pb, 2.5 mol % to 6.7 mol % of La, more than 0 mol % to 4.4 mol % of Na, 42.6 mol % to 47.6 mol % of Zr, and more than 0 mol % to 6.2 mol % of Ti based on 100 mol % of a total amount of the Pb, the La, the Na, the Zr, and the Ti in the ceramic powder.

### CROSS REFERENCE TO RELATED APPLICATIONS

The present application is a continuation of International application No. PCT/JP2018/002002, filed Jan. 23, 2018; and a continuation of International application No. PCT/JP2019/001779, filed Jan. 22, 2019, which claims priority to International application No. PCT/JP2018/002002, filed Jan. 23, 2018, the entire contents of each of which are incorporated herein by reference.

### FIELD OF THE INVENTION

The present invention relates to a ceramic powder, a dielectric ceramic, and an electronic component.

### BACKGROUND OF THE INVENTION

As a dielectric ceramic included in an electronic component such as a capacitor, titanium oxide-based materials, barium titanate-based materials, and the like have been conventionally used.

Furthermore, as a dielectric ceramic, lead zirconate titanate (PZT)-based materials are also known. For example, Patent Document 1 discloses a PZT-based ceramic material represented by a predetermined composition formula and a capacitor in which the ceramic material is used.

In the ceramic material described in Patent Document 1, a part of the Pb is substituted with a rare earth element such as La and an element such as Na, and it is described that a large inversion electric field strength and/or a large relative permittivity can be obtained.

Patent Document 1: Japanese Patent Application Laid-Open No. 2015-518459

### SUMMARY OF THE INVENTION

In recent years, usage of capacitors has been increasing. For example, capacitors used for automotive application are required to have high specific resistance at high temperature.

Furthermore, the capacitors are required to have the maximum relative permittivity at room temperature in a high electric field and to have the high maximum relative permittivity.

In Patent Document 1, a composition formula is described in claims, but in Examples, compositions of ceramic materials such as Pb_{0.895-0.5x}La_{0.07}NaₓZr_{0.86}Ti_{0.14}O₃ (0≤x≤0.08) and Pb_{0.88-0.5x}La_{0.08}NaₓZr_{0.80}Ti_{0.20}O₃ (x=0, 0.005, 0.01, 0.03) only are described.

However, it has been found that when the ceramic material described in the Examples of Patent Document 1 is used, there is a problem that a capacitor cannot be obtained that satisfies both the property required in a high temperature environment and the property required in a high electric field environment.

The present invention has been made to solve the above-mentioned problems, and an object of the present invention is to provide a ceramic powder that is a raw material of a dielectric ceramic having a sufficient property both in a high temperature environment and in a high electric field environment. Another object of the present invention is to provide the dielectric ceramic and an electronic component in which the dielectric ceramic is used.

The ceramic powder according to the present invention includes 39.9 mol % to 47.0 mol % of Pb, 2.5 mol % to 6.7 mol % of La, more than 0 mol % to 4.4 mol % of Na, 42.6 mol % to 47.6 mol % of Zr, and more than 0 mol % to 6.2 mol % of Ti based on 100 mol % of a total amount of the Pb, the La, the Na, the Zr, and the Ti in the ceramic powder.

The dielectric ceramic according to the present invention mainly includes an oxide containing 40.6 mol % to 46.5 mol % of Pb, 2.5 mol % to 6.6 mol % of La, more than 0 mol % to 4.0 mol % of Na, 42.3 mol % to 47.5 mol % of Zr, and more than 0 mol % and 6.2 mol % of Ti based on 100 mol % of a total amount of the Pb, the La, the Na, the Zr, and the Ti in the dielectric ceramic.

The electronic component according to the present invention includes a ceramic element including the dielectric ceramic according to the present invention and an electrode formed on the ceramic element.

According to the present invention, it is possible to provide a ceramic powder that is a raw material of a dielectric ceramic having a sufficient property both in a high temperature environment and in a high electric field environment, the dielectric ceramic, and an electronic component in which the dielectric ceramic is used. The dielectric ceramic according to the present invention has a property that the specific resistance at high temperature is high, and a property that the maximum relative permittivity at room temperature is obtained in a high electric field and the maximum relative permittivity is high.

### BRIEF EXPLANATION OF THE DRAWINGS

FIG. 1 is a sectional view schematically showing one example of a multilayer ceramic capacitor.

FIG. 2 is an LT sectional view explaining a method of measuring the thickness of a dielectric layer.

FIG. 3 is an LT sectional view explaining a method of measuring the L dimension of an effective electrode portion.

FIG. 4 is a WT sectional view explaining a method of measuring the W dimension of an effective electrode portion.

### DETAILED DESCRIPTION OF THE INVENTION

Hereinafter, the ceramic powder, the dielectric ceramic, and the electronic component according to the present invention will be described.

However, the present invention is not limited to the following embodiments, and can be appropriately modified and applied as long as the gist of the present invention is not modified.

[Ceramic Powder]

Hereinafter, the ceramic powder according to the present invention will be described.

The ceramic powder according to the present invention is a raw material of the dielectric ceramic according to the present invention. As described in detail herein, the dielectric ceramic according to the present invention is a ceramic material mainly including an oxide containing Pb, La, Na, Zr, and Ti. That is, the ceramic powder according to the present invention is a raw material of the dielectric ceramic mainly including an oxide containing Pb, La, Na, Zr, and Ti.

The ceramic powder according to the present invention is a mixture of a raw material of a Pb element (hereinafter, also referred to as a Pb source), a raw material of an La element (hereinafter, also referred to as an La source), a raw material of an Na element (hereinafter, also referred to as an Na source), a raw material of a Zr element (hereinafter, also referred to as a Zr source), and a raw material of a Ti element (hereinafter, also referred to as a Ti source).

Examples of the form of the raw material of each element include oxides and compounds that become an oxide in a calcining step (for example, a carbonate), and any form may be used. For example, Pb₃O₄, La₂O₃, Na₂CO₃, ZrO₂, and TiO₂ can be used as a Pb source, an La source, an Na source, a Zr source, and a Ti source, respectively. The raw materials are mixed to obtain the ceramic powder according to the present invention.

The ceramic powder according to the present invention contains 39.9 mol % to 47.0 mol % of Pb; 2.5 mol % to 6.7 mol % of La; more than 0 mol % to 4.4 mol % of Na; 42.6 mol % to 47.6 mol % (or to 46.7 mol %) of Zr; and more than 0 mol % to 6.2 mol % of Ti based on 100 mol % of a total amount of the Pb, the La, the Na, the Zr, and the Ti in the ceramic powder.

The ceramic powder according to the present invention preferably contains 0.5 mol % to 4.4 mol % of the Na; and 2.5 mol % to 6.2 mol % of the Ti.

The content of each element contained in the ceramic powder can be determined by a composition analysis using inductively coupled plasma atomic emission spectroscopy (ICP-AES).

In the ceramic powder according to the present invention, when the charge composition of the target dielectric ceramic is represented by the following formula:

(Pbₐ₁La_{b1}Na_{c1})₁₊ₘ₁(Zr_{d1}Tiₑ₁)O₃, it is preferable that

0.80≤a1≤0.94,

0.05≤b1≤0.13,

0<c1<0.08,

0.87≤d1<1.00,

0<e1≤0.13,

a1+b1+c1=1, d1+e1=1, and −0.05≤m1≤0.05.

It is particularly preferable that

0.01≤c1≤0.08,

0.87≤d1≤0.95, and

0.05≤e1≤0.13.

It is also preferable that

0.87≤d1≤0.93, and

0.07≤e1≤0.13.

Furthermore, it is preferable that

0.91≤d1<1.00, and

0<e1≤0.09.

The ceramic powder according to the present invention preferably has an average primary grain size of 0.1 μm to 1.0 μm, and more preferably 0.2 μm to 0.5 μm. The ceramic powder is observed with a scanning electron microscope, and n=100 primary grain sizes are measured along one axial direction using image processing software to calculate the average primary grain size.

The ceramic powder according to the present invention is subjected to a firing treatment (also referred to as a heat treatment) to obtain the dielectric ceramic according to the present invention. If necessary, the ceramic powder may be subjected to a pretreatment such as evaporative drying before the heat treatment, and a post-treatment such as pulverization after the heat treatment.

[Dielectric Ceramic]

Hereinafter, the dielectric ceramic according to the present invention will be described.

The dielectric ceramic according to the present invention is a ceramic material mainly including an oxide containing Pb, La, Na, Zr, and Ti.

In the dielectric ceramic according to the present invention, the phrase “mainly including” means including at a content of 90% by weight or more. That is, the dielectric ceramic according to the present invention is a ceramic material including an oxide containing Pb, La, Na, Zr, and Ti at a content of 90% by weight or more. The dielectric ceramic according to the present invention preferably includes the oxide at a content of 95% by weight or more, and more preferably 99% by weight or more.

In the dielectric ceramic according to the present invention, the oxide containing Pb, La, Na, Zr, and Ti is preferably a perovskite oxide represented by the general formula ABO₃. It is considered that the perovskite oxide has a structure in which a Pb ion is positioned at the apex of the cube of the unit cell (A site), a Ti ion and a Zr ion are positioned at the center of the cube (B site), an O ion is positioned at the center of the cube surface, and an La ion and an Na ion occupy a part of the A site.

The dielectric ceramic according to the present invention may include a ceramic as an accessory component other than the oxide containing Pb, La, Na, Zr, and Ti. For example, an oxide such as a pyrochlore oxide, PbO, or ZrO₂ may be included.

The dielectric ceramic according to the present invention contains 40.6 mol % to 46.5 mol % of Pb; 2.5 mol % to 6.6 mol % of La; more than 0 mol % to 4.0 mol % of Na; 42.3 mol % to 47.5 mol % (or 47.2 mol %) of Zr; and more than 0 mol % to 6.2 mol % of Ti based on 100 mol % of a total amount of the Pb, the La, the Na, the Zr, and the Ti in the dielectric ceramic.

The dielectric ceramic according to the present invention preferably contains 0.5 mol % to 4.0 mol % of the Na, and 2.5 mol % to 6.2 mol % of the Ti.

As described above, the dielectric ceramic according to the present invention has a property that the specific resistance at high temperature is high, and a property that the maximum relative permittivity at room temperature is obtained in a high electric field and the maximum relative permittivity is high.

The content of each element contained in the dielectric ceramic can be determined by a composition analysis using inductively coupled plasma atomic emission spectroscopy (ICP-AES). When the dielectric ceramic according to the present invention includes a ceramic other than the oxide containing Pb, La, Na, Zr, and Ti, the phrase “content of each element” means the content of each element contained in the entire dielectric ceramic. Note that the main component and the accessory component can be distinguished by, for example, structural analysis using X-ray diffraction (XRD).

In the dielectric ceramic according to the present invention, when the composition of the dielectric ceramic is represented by the following formula:

(Pbₐ₂La_{b2}Na_{c2})₁₊ₘ₂(Zr_{d2}Tiₑ₂)O₃, it is preferable that

0.80≤a2≤0.94,

0.05≤b2≤0.13,

0<c2≤0.08,

0.87≤d2<1.00,

0<e2≤0.13,

a2+b2+c2=1, d2+e2=1, and −0.07≤m2≤0.07.

It is particularly preferable that

0.01≤c2≤0.08,

0.87≤d2≤0.95, and

0.05≤e2≤0.13.

It is also preferable that

0.87≤d2≤0.93, and

0.07≤e2≤0.13.

Furthermore, it is preferable that

0.91≤d2<1.00, and

0<e2≤0.09.

In this case, particularly high insulation resistance can be exhibited.

Note that even when the dielectric ceramic according to the present invention includes a ceramic having no composition represented by the formula shown above, the composition shown above means the composition in which it is assumed that the entire dielectric ceramic has the composition represented by the formula shown above.

In the present invention, the content and the composition formula of the elements contained in the ceramic powder and the dielectric ceramic prepared using the ceramic powder are specified, but the rate of the change from the ceramic powder to the dielectric ceramic is not constant. Since a volatile element, Pb and Na are easily affected by firing.

[Electronic Component]

The electronic component in which an electrode is formed on the dielectric ceramic according to the present invention is also provided by the present invention.

Hereinafter, a multilayer ceramic capacitor that is an embodiment of the electronic component according to the present invention will be described.

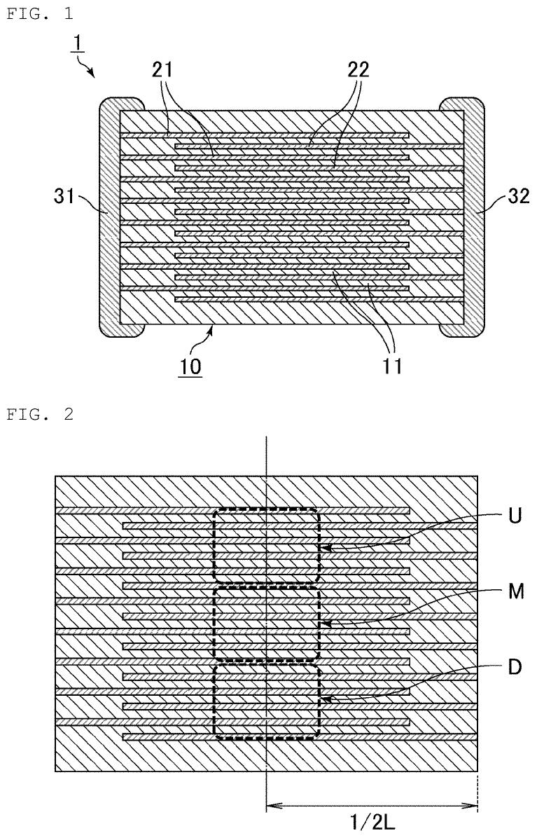

FIG. 1 is a sectional view schematically showing one example of the multilayer ceramic capacitor.

The multilayer ceramic capacitor 1 shown in FIG. 1 includes a rectangular parallelepiped ceramic element 10. The ceramic element 10 includes a plurality of stacked dielectric layers 11. In the multilayer ceramic capacitor 1 shown in FIG. 1, the dielectric layer 11 included in the ceramic element 10 includes the dielectric ceramic according to the present invention.

A pair of internal electrodes 21 and 22 are provided inside the ceramic element 10. The internal electrodes 21 and 22 are formed along the interface between the dielectric layers 11. The internal electrode 21 extended to one end face of the ceramic element 10 and the internal electrode 22 extended to the other end face of the ceramic element 10 are arranged alternately inside the ceramic element 10 so that the electrostatic capacitance can be obtained via the dielectric layer 11.

A pair of external electrodes 31 and 32 are provided on the surface of the ceramic element 10. The external electrode 31 is electrically connected to the internal electrode 21, and the external electrode 32 is electrically connected to the internal electrode 22. As a result, the electrostatic capacitance can be taken out.

In the electronic component according to the present invention, the type of the metal included in the internal electrode is not particularly limited, and examples of the metal include precious metals such as platinum and non-precious metals such as copper and an alloy containing copper.

Among the metals, the non-precious metals are preferable. The atmosphere during the firing is not particularly limited as long as the metal of the internal electrode is not oxidized.

In the electronic component according to the present invention, the type of the metal included in the external electrode is not particularly limited, and examples of the metal include precious metals such as platinum and non-precious metals such as copper and an alloy containing copper.

Among the metals, the non-precious metals are preferable. The type of the metal included in the external electrode may be the same as or different from the type of the metal included in the internal electrode. Furthermore, a plating layer may be formed on the surface of the external electrode.

When the electronic component such as the multilayer ceramic capacitor is manufactured, the external electrode and the internal electrode may be co-fired. In this case, the atmosphere during the firing is not particularly limited as long as the internal electrode and the external electrode are not oxidized.

### EXAMPLES

Hereinafter, examples that more specifically disclose the present invention will be described. Note that the present invention is not limited to the examples.

[Preparation of Dielectric Raw Material Compound (Ceramic Powder)]

As a starting raw material, a Pb source, an La source, an Na source, a Zr source, and a Ti source were blended in various ratios, and mixed with a ball mill using water as a medium for 36 hours. The compounds used as a raw material for each element are Pb₃O₄, La₂O₃, Na₂CO₃, ZrO₂, and TiO₂. Thereafter, the mixture was subjected to evaporative drying, heat treatment, and dry pulverization to prepare a dielectric raw material compound (hereinafter, also simply referred to as a raw material compound).

[Preparation of Multilayer Ceramic Capacitor]

To each of the prepared dielectric raw material compounds, a polyvinyl butyral-based binder and an organic solvent such as ethanol were added, and the mixture was wet-mixed for a predetermined time with a ball mill to prepare a ceramic slurry. Thereafter, a ceramic green sheet was formed by a comma coating method. The thickness of the ceramic green sheet was adjusted so that the dielectric layer has a thickness of 20 μm after the firing.

Next, on the ceramic green sheet, a conductive paste mainly including Pt was screen-printed to form a conductive paste layer that is an internal electrode.

The ceramic green sheet on which the conductive paste layer was formed were stacked so that the sides from which the conductive paste was drawn out were alternated. As a result, a stacked body block was obtained. The stacked body block was cut to obtain a raw stacked chip.

The raw stacked chip was heated to a temperature of 450° C. in an air atmosphere to burn the binder. After the burning of the binder, the stacked chip was fired in an air atmosphere.

On both end faces of the ceramic laminate obtained after the firing, Pt electrodes were baked to form external electrodes electrically connected to the internal electrodes.

Thus, a multilayer ceramic capacitor was prepared.

[Evaluation of Raw Material Compound and Multilayer Ceramic Capacitor]

The prepared raw material compound and the multilayer ceramic capacitor was evaluated as described below.

1. Length Measurement

1.1 Polishing

1.1.1 LT Surface (Length/Thickness Surface) Polishing

n=10 multilayer ceramic capacitors (hereinafter, referred to as samples) were prepared, the circumference of each sample was solidified with a resin, and the LT side surface was polished with a polishing machine.

The polishing was completed at a depth of about ½ of the width in the W direction (width direction) of the sample, and an LT section was obtained. Then, in order to eliminate the sagging of the internal electrode due to the polishing, the polished surface was processed by ion milling after the polishing was completed.

1.1.2 WT Surface (Width/Thickness Surface) Polishing

n=10 multilayer ceramic capacitors (hereinafter, referred to as samples) were prepared, the circumference of each sample was solidified with a resin, and the WT side surface was polished with a polishing machine.

The polishing was completed at a depth of about ½ of the length in the L direction (length direction) of the sample, and a WT section was obtained. Then, in order to eliminate the sagging of the internal electrode due to the polishing, the polished surface was processed by ion milling after the polishing was completed.

1.2 Observation

1.2.1 Measurement of Thickness of Dielectric Layer (Element Thickness)

FIG. 2 is an LT sectional view explaining a method of measuring the thickness of the dielectric layer.

As shown in FIG. 2, a perpendicular line perpendicular to the internal electrodes was drawn at about ½ of the length in the L direction of the LT section. Next, the area where the internal electrodes were stacked was divided into three equal parts in the T direction (thickness direction), that is, divided into three areas: an upper area U, a middle area M, and a lower area D. Then, in each area, the thickness of each of the three dielectric layers on the perpendicular line was measured, and the average was determined. Note that, in each area, the outermost dielectric layer and the dielectric layers connected to each other across the internal electrode were excluded from the measurement target. The latter dielectric layers are caused by missing a part of the electrode during the preparation process and were excluded from the measurement target because in such a state, the distance between the electrodes is longer than the effective part of the dielectric to be measured and the property cannot be measured accurately.

The thickness of the dielectric layer was measured using a scanning electron microscope.

1.2.2 Measurement of L Dimension of Effective Electrode Portion (LT Electrode Dimension)

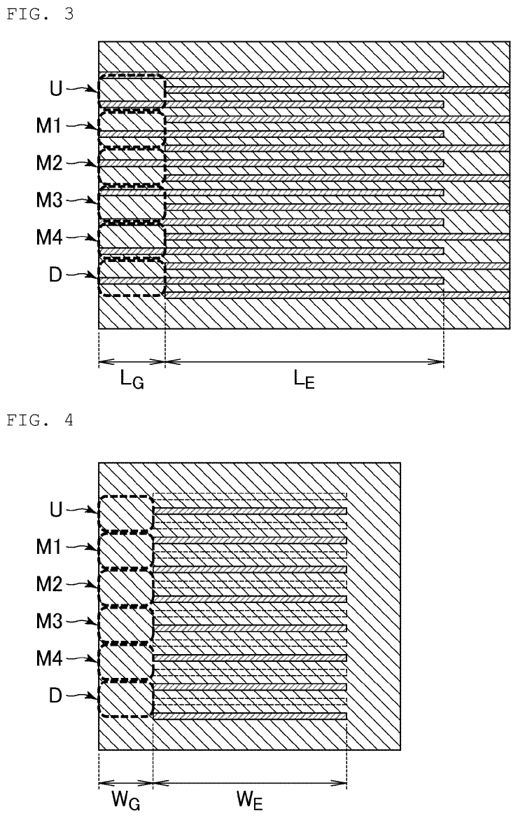

FIG. 3 is an LT sectional view explaining a method of measuring the L dimension of an effective electrode portion. As shown in FIG. 3, the area sandwiched between the end of the internal electrode and the end of the sample that are opposite to each other (L gap) was divided into six equal parts in the T direction, that is, divided into six areas: an upper area U, middle areas M1, M2, M3, and M4, and a lower area D. The upper area U and the lower area D were excluded, and the L gap dimension L_{G} was measured in the four areas, that is, the middle areas M1, M2, M3, and M4. Then, the L gap dimension was measured on the opposite side in the same manner, and the average of the L gap dimensions at eight points was determined.

Furthermore, the upper area U and the lower area D were excluded, the L dimension of the sample was measured in the four areas, that is, the middle areas M1, M2, M3, and M4, and the average was determined.

The L dimension of the effective electrode portion L_{E} was determined by subtracting the average of the L gap dimensions from the average of the L dimensions.

The L dimension and the L gap dimension were measured using an optical microscope.

1.2.3 Measurement of W Dimension of Effective Electrode Portion (WT Electrode Dimension)

FIG. 4 is a WT sectional view explaining a method of measuring the W dimension of the effective electrode portion.

As shown in FIG. 4, the area sandwiched between the outermost internal electrode and the end of the sample in the W direction (width direction) (W gap) was divided into six equal parts in the T direction, that is, divided into six areas: an upper area U, middle areas M1, M2, M3, and M4, and a lower area D. The upper area U and the lower area D were excluded, and the W gap dimension W_{G} was measured in the four areas, that is, the middle areas M1, M2, M3, and M4. Then, the W gap dimension was measured on the opposite side in the same manner, and the average of the W gap dimensions at eight points was determined.

Furthermore, the upper area U and the lower area D were excluded, the W dimension of the sample was measured in the four areas, that is, the middle areas M1, M2, M3, and M4, and the average was determined.

The W dimension of the effective electrode portion W_{E} was determined by subtracting the average of the W gap dimensions from the average of the W dimensions.

The W dimension and the W gap dimension were measured using an optical microscope.

2. Composition Analysis

The prepared raw material compound and the multilayer ceramic capacitor were subjected to a composition analysis using inductively coupled plasma atomic emission spectroscopy (ICP-AES). In order to quantify each element, a standard solution was used, a calibration curve was prepared in a range of the known concentration, and the sample concentration was relatively determined.

Based on 100 mol % of the total amount of the Pb, the La, the Na, the Zr, and the Ti, the ratio of each element was determined. Table 1 shows the composition of the dielectric raw material compound (ceramic powder), and Table 2 shows the composition of the dielectric ceramic.

Furthermore, the composition shown in Table 1 was converted into the chemical formula (Pbₐ₁La_{b1}Na_{c1})₁₊ₘ₁(Zr_{d1}Tiₑ₁)O₃, and the molar part of each of the Pb, the La, the Ti, and the Na was determined based on d₁ mol of the Zr. Table 3 shows the composition of the dielectric raw material compound (ceramic powder).

In the same manner, the composition shown in Table 2 was converted into the chemical formula (Pbₐ₂La_{b2}Na_{c2})₁₊ₘ₂ (Zr_{d2}Tiₑ₂)O₃, and the molar part of each of the Pb, the La, the Ti, and the Na was determined based on d₂ mol of the Zr. Table 4 shows the composition of the dielectric ceramic.

Note that only in Experimental Example No. 4, the molar part of each of the Pb, the La, the Zr, and the Na based on e₁ or e₂ mol of the Ti is shown.

TABLE 1
(Ceramic powder)

| Experimental | Pb | La | Na | Zr | Ti | Total |
|---|---|---|---|---|---|---|
| Example No. | (mol %) | (mol %) | (mol %) | (mol %) | (mol %) | (mol %) |
| * 1 | 44.4 | 3.0 | 2.5 | 50.1 | 0.0 | 100 |
| 2 | 44.4 | 3.0 | 2.5 | 45.1 | 5.0 | 100 |
| * 3 | 44.4 | 3.0 | 2.5 | 25.1 | 25.0 | 100 |
| * 4 | 44.4 | 3.0 | 2.5 | 0.0 | 50.1 | 100 |
| * 5 | 46.6 | 2.7 | 0.0 | 44.4 | 6.3 | 100 |
| 6 | 45.5 | 2.6 | 2.5 | 43.2 | 6.2 | 100 |
| 7 | 44.8 | 2.6 | 3.9 | 42.6 | 6.1 | 100 |
| 8 | 43.8 | 4.0 | 2.5 | 43.5 | 6.2 | 100 |
| 9 | 43.1 | 3.9 | 4.0 | 42.9 | 6.1 | 100 |
| * 10 | 48.3 | 1.3 | 0.0 | 40.3 | 10.1 | 100 |
| * 11 | 46.7 | 2.7 | 0.0 | 40.5 | 10.1 | 100 |
| * 12 | 43.7 | 3.5 | 2.5 | 43.3 | 7.0 | 100 |
| 13 | 40.4 | 5.9 | 4.4 | 44.9 | 4.4 | 100 |
| 14 | 44.3 | 4.0 | 1.5 | 45.7 | 4.5 | 100 |
| 15 | 42.0 | 6.2 | 0.5 | 46.7 | 4.6 | 100 |
| 16 | 44.5 | 3.0 | 2.5 | 46.0 | 4.0 | 100 |
| 17 | 43.7 | 4.0 | 2.5 | 45.8 | 4.0 | 100 |
| 18 | 44.3 | 3.0 | 2.5 | 46.7 | 3.5 | 100 |
| * 19 | 39.3 | 7.0 | 4.0 | 42.7 | 7.0 | 100 |
| 20 | 39.9 | 6.7 | 3.5 | 44.9 | 5.0 | 100 |
| 21 | 47.0 | 2.5 | 0.5 | 45.0 | 5.0 | 100 |
| * 22 | 39.5 | 7.4 | 2.5 | 45.5 | 5.1 | 100 |
| * 23 | 45.6 | 1.6 | 4.8 | 43.2 | 4.8 | 100 |
| * 24 | 44.8 | 1.9 | 5.6 | 42.9 | 4.8 | 100 |
| 25 | 44.4 | 3.0 | 2.5 | 47.6 | 2.5 | 100 |

TABLE 2
(Dielectric ceramic)

| Experimental | Pb | La | Na | Zr | Ti | Total |
|---|---|---|---|---|---|---|
| Example No. | (mol %) | (mol %) | (mol %) | (mol %) | (mol %) | (mol %) |
| * 1 | 45.3 | 3.1 | 2.1 | 49.5 | 0.0 | 100 |
| 2 | 45.4 | 3.0 | 2.3 | 44.4 | 4.9 | 100 |
| * 3 | 45.5 | 3.2 | 1.9 | 25.0 | 24.4 | 100 |
| * 4 | 46.0 | 3.0 | 2.3 | 0.0 | 48.7 | 100 |
| * 5 | 46.8 | 2.7 | 0.0 | 44.0 | 6.5 | 100 |
| 6 | 45.6 | 2.7 | 2.6 | 42.9 | 6.2 | 100 |
| 7 | 45.0 | 2.6 | 4.0 | 42.3 | 6.1 | 100 |
| 8 | 44.3 | 4.0 | 2.6 | 42.9 | 6.2 | 100 |
| 9 | 43.7 | 4.0 | 3.9 | 42.3 | 6.1 | 100 |
| * 10 | 48.9 | 1.3 | 0.0 | 39.9 | 9.9 | 100 |
| * 11 | 46.9 | 2.7 | 0.0 | 40.3 | 10.1 | 100 |
| * 12 | 43.7 | 3.4 | 3.1 | 42.3 | 7.5 | 100 |
| 13 | 41.1 | 5.9 | 4.0 | 44.7 | 4.3 | 100 |
| 14 | 44.8 | 4.0 | 1.3 | 45.4 | 4.5 | 100 |
| 15 | 42.5 | 6.1 | 0.5 | 46.3 | 4.6 | 100 |
| 16 | 44.0 | 3.0 | 2.5 | 46.5 | 4.0 | 100 |
| 17 | 43.3 | 4.0 | 2.5 | 46.2 | 4.0 | 100 |
| 18 | 43.8 | 3.0 | 2.5 | 47.2 | 3.5 | 100 |
| * 19 | 38.9 | 7.0 | 3.9 | 43.2 | 7.0 | 100 |
| 20 | 40.6 | 6.6 | 3.4 | 44.5 | 4.9 | 100 |
| 21 | 46.5 | 2.5 | 0.5 | 45.5 | 5.0 | 100 |
| * 22 | 39.0 | 7.5 | 2.5 | 45.9 | 5.1 | 100 |
| * 23 | 45.1 | 1.6 | 4.8 | 43.6 | 4.9 | 100 |
| * 24 | 44.3 | 1.9 | 5.7 | 43.3 | 4.8 | 100 |
| 25 | 44.5 | 3.0 | 2.5 | 47.5 | 2.5 | 100 |

TABLE 3
(Ceramic powder)

| Experimental | Pb | La | Na | Zr | Ti | — |
|---|---|---|---|---|---|---|
| Example No. | a1 | b1 | c1 | d1 | e1 | m1 |
| * 1 | 0.89 | 0.06 | 0.05 | 1.00 | 0.00 | 0.00 |
| 2 | 0.89 | 0.06 | 0.05 | 0.90 | 0.10 | 0.00 |
| * 3 | 0.89 | 0.06 | 0.05 | 0.50 | 0.50 | 0.00 |
| * 4 | 0.89 | 0.06 | 0.05 | 0.00 | 1.00 | 0.00 |
| * 5 | 0.95 | 0.05 | 0.00 | 0.87 | 0.13 | −0.03 |
| 6 | 0.90 | 0.05 | 0.05 | 0.87 | 0.13 | 0.02 |
| 7 | 0.87 | 0.05 | 0.08 | 0.87 | 0.13 | 0.05 |
| 8 | 0.87 | 0.08 | 0.05 | 0.87 | 0.13 | 0.01 |
| 9 | 0.85 | 0.07 | 0.08 | 0.87 | 0.13 | 0.04 |
| * 10 | 0.97 | 0.03 | 0.00 | 0.80 | 0.20 | −0.01 |
| * 11 | 0.95 | 0.05 | 0.00 | 0.80 | 0.20 | −0.03 |
| * 12 | 0.88 | 0.07 | 0.05 | 0.86 | 0.14 | −0.01 |
| 13 | 0.80 | 0.12 | 0.08 | 0.91 | 0.09 | 0.03 |
| 14 | 0.89 | 0.08 | 0.03 | 0.91 | 0.09 | −0.01 |
| 15 | 0.86 | 0.13 | 0.01 | 0.91 | 0.09 | −0.05 |
| 16 | 0.89 | 0.06 | 0.05 | 0.92 | 0.08 | 0.00 |
| 17 | 0.87 | 0.08 | 0.05 | 0.92 | 0.08 | 0.01 |
| 18 | 0.89 | 0.06 | 0.05 | 0.93 | 0.07 | −0.01 |
| * 19 | 0.78 | 0.14 | 0.08 | 0.86 | 0.14 | 0.01 |
| 20 | 0.80 | 0.13 | 0.07 | 0.90 | 0.10 | 0.00 |
| 21 | 0.94 | 0.05 | 0.01 | 0.90 | 0.10 | 0.00 |
| * 22 | 0.80 | 0.15 | 0.05 | 0.90 | 0.10 | −0.02 |
| * 23 | 0.88 | 0.03 | 0.09 | 0.90 | 0.10 | 0.08 |
| * 24 | 0.85 | 0.04 | 0.11 | 0.90 | 1.00 | 0.10 |
| 25 | 0.89 | 0.06 | 0.05 | 0.95 | 0.05 | 0.00 |

TABLE 4
(Dielectric ceramic)

| Experimental | Pb | La | Na | Zr | Ti | — |
|---|---|---|---|---|---|---|
| Example No. | a2 | b2 | c2 | d2 | e2 | m2 |
| * 1 | 0.88 | 0.07 | 0.05 | 1.00 | 0.00 | −0.07 |
| 2 | 0.89 | 0.06 | 0.05 | 0.90 | 0.10 | −0.07 |
| * 3 | 0.90 | 0.06 | 0.04 | 0.51 | 0.49 | 0.01 |
| * 4 | 0.90 | 0.06 | 0.04 | 0.01 | 0.99 | 0.01 |
| * 5 | 0.94 | 0.06 | 0.00 | 0.87 | 0.13 | −0.04 |
| 6 | 0.90 | 0.05 | 0.05 | 0.87 | 0.13 | 0.00 |
| 7 | 0.90 | 0.05 | 0.05 | 0.88 | 0.12 | −0.02 |
| 8 | 0.87 | 0.08 | 0.05 | 0.87 | 0.13 | 0.04 |
| 9 | 0.85 | 0.08 | 0.07 | 0.87 | 0.13 | 0.07 |
| * 10 | 0.97 | 0.03 | 0.00 | 0.80 | 0.20 | −0.02 |
| * 11 | 0.94 | 0.06 | 0.00 | 0.80 | 0.20 | −0.06 |
| * 12 | 0.87 | 0.07 | 0.06 | 0.85 | 0.15 | 0.02 |
| 13 | 0.81 | 0.11 | 0.08 | 0.91 | 0.09 | 0.04 |
| 14 | 0.89 | 0.08 | 0.03 | 0.91 | 0.09 | 0.00 |
| 15 | 0.87 | 0.12 | 0.01 | 0.91 | 0.09 | −0.03 |
| 16 | 0.89 | 0.06 | 0.05 | 0.92 | 0.08 | 0.00 |
| 17 | 0.87 | 0.08 | 0.05 | 0.92 | 0.08 | 0.01 |
| 18 | 0.89 | 0.06 | 0.05 | 0.93 | 0.07 | −0.01 |
| * 19 | 0.78 | 0.14 | 0.08 | 0.86 | 0.14 | −0.01 |
| 20 | 0.80 | 0.13 | 0.07 | 0.90 | 0.10 | 0.02 |
| 21 | 0.94 | 0.05 | 0.01 | 0.90 | 0.10 | −0.02 |
| * 22 | 0.81 | 0.14 | 0.05 | 0.90 | 0.10 | −0.03 |
| * 23 | 0.85 | 0.05 | 0.10 | 0.90 | 0.10 | 0.05 |
| * 24 | 0.85 | 0.04 | 0.11 | 0.90 | 0.10 | 0.08 |
| 25 | 0.89 | 0.06 | 0.05 | 0.95 | 0.05 | 0.00 |

In Tables 1 to 4, Experimental Examples marked with * are comparative examples outside the scope of the present invention.

3. Electrical Property

3.1 High-Temperature IR Measurement

Ten samples of each multilayer ceramic capacitor prepared as described above were prepared. The sample of each multilayer ceramic capacitor was kept at 200° C. for 5 minutes, then the insulation resistance (IR) value was measured when 10 kV/mm of a DC voltage was applied for 120 seconds, and the average of 10 values was determined.

Using the thickness of the dielectric layer, the L dimension of the effective electrode portion, and the W dimension of the effective electrode portion determined in “1. Length measurement”, the specific resistance was calculated from the insulation resistance value when 10 kV/mm of a DC voltage was applied for 120 seconds. Table 5 shows the specific resistance in each Experimental Example.

3.2 Bias Characteristic Measurement

Ten samples of each multilayer ceramic capacitor prepared as described above were prepared. The sample was put in a metal container, kept at 300° C. for 60 minutes, and then left at 25° C. for 24 hours.

The electrostatic capacitance of each multilayer ceramic capacitor after treated as described above was measured when 1 kHz and 0.1 kV/mm of an AC voltage and a DC voltage set at 1 kV/mm intervals in the range of an electric field strength of 0 to 30 kV/mm were applied for 60 seconds, and the average of 10 values was determined.

Using the thickness of the dielectric layer, the L dimension of the effective electrode portion, and the W dimension of the effective electrode portion determined in “1. Length measurement”, the relative permittivity was calculated from the electrostatic capacitance. Table 5 shows the electric field strength when the relative permittivity is maximum in the range of 0 to 30 kV/mm and the maximum relative permittivity.

TABLE 5

| | Specific | At maximum relative permittivity | |
|---|---|---|---|
| | resistance at | with DC voltage applied at 25° C. | |
| | 200° C. | Electric field | Relative |
| Experimental | log ρ | strength | permittivity |
| Example No. | (Ωm) | (kV/mm) | — |
| * 1 | 9.0 | 16 | 192 |
| 2 | 9.2 | 15 | 2140 |
| * 3 | 9.5 | 0 | 1977 |
| * 4 | 7.8 | 7 | 529 |
| * 5 | 9.5 | 6 | 1873 |
| 6 | 9.6 | 11 | 1400 |
| 7 | 9.3 | 10 | 1566 |
| 8 | 9.4 | 13 | 1416 |
| 9 | 9.6 | 13 | 1337 |
| * 10 | 8.2 | 0 | 705 |
| * 11 | 9.5 | 0 | 1402 |
| * 12 | 9.3 | 8 | 2085 |
| 13 | 10.2 | 20 | 1059 |
| 14 | 10.3 | 16 | 1536 |
| 15 | 10.0 | 16 | 1610 |
| 16 | 10.2 | 15 | 1116 |
| 17 | 10.3 | 18 | 1020 |
| 18 | 10.2 | 16 | 1258 |
| * 19 | 8.0 | 20 | 946 |
| 20 | 9.4 | 20 | 1100 |
| 21 | 10.4 | 10 | 1027 |
| * 22 | 7.8 | 19 | 783 |
| * 23 | 8.4 | 12 | 1353 |
| * 24 | 7.9 | 14 | 1421 |
| 25 | 12.6 | 16 | 1375 |

In Experimental Examples No. 2, 6 to 9, 13 to 18, 20, 21, and 25, both the properties (1) and (2) shown below are obtained.

(1) The specific resistance at 200° C. is higher than Log ρ=8.5 Ωm.

(2) The maximum relative permittivity at room temperature is obtained in 10 kV/mm or more of a high electric field and the maximum relative permittivity is 1,000 or more.

In particular, in Experimental Examples No. 13 to 18, 21, and 25, the specific resistance at 200° C. is Log ρ=10.0 Ωm or more.

On the other hand, in Experimental Examples No. 1, 3 to 5, 10 to 12, 19, and 22 to 24, only one of the properties (1) and (2) is obtained.

### DESCRIPTION OF REFERENCE SYMBOLS

1 Multilayer ceramic capacitor

10 Ceramic element

11 Dielectric layer

21, 22 Internal electrode

31, 32 External electrode

U Upper area

M, M1, M2, M3, M4 Middle area

D Lower area

L_{E} L dimension of effective electrode portion

L_{G} L gap dimension

W_{E} W dimension of effective electrode portion

W_{G} W gap dimension

1. A ceramic powder comprising:
39.9 mol % to 47.0 mol % of Pb;
2.5 mol % to 6.7 mol % of La;
more than 0 mol % to 4.4 mol % of Na;
42.6 mol % to 47.6 mol % of Zr; and
more than 0 mol % to 6.2 mol % of Ti based on 100 mol % of a total amount of the Pb, the La, the Na, the Zr, and the Ti in the ceramic powder.

2. The ceramic powder according to claim 1, wherein:
the Na is 0.5 mol % to 4.4 mol %; and
the Ti is 2.5 mol % to 6.2 mol %.

3. The ceramic powder according to claim 1, wherein the ceramic powder has an average primary grain size of 0.1 μm to 1.0 μm.

4. The ceramic powder according to claim 1, wherein the ceramic powder has an average primary grain size of 0.2 μm to 0.5 μm.

5. The ceramic powder according to claim 1, wherein, when a charge composition of a target dielectric ceramic is:
(Pbₐ₁La_{b1}Na_{c1})₁₊ₘ₁(Zr_{d1}Tiₑ₁)O₃, then
0.80≤a1≤0.94,
0.05≤b1≤0.13,
0<c1≤0.08,
0.87≤d1<1.00,
0<e1≤0.13,
a+b1+c1=1, d1+e1=1, and −0.05≤m1≤0.05.

6. The ceramic powder according to claim 5, wherein
0.01≤c1≤0.08,
0.87≤d1≤0.95, and
0.05≤e1≤0.13.

7. The ceramic powder according to claim 6, wherein
0.87≤d1≤0.93, and
0.07≤e1≤0.13.

8. The ceramic powder according to claim 5, wherein
0.91≤d1<1.00, and
0<e1≤0.09.

9. A dielectric ceramic mainly including an oxide containing:
40.6 mol % to 46.5 mol % of Pb;
2.5 mol % to 6.6 mol % of La;
more than 0 mol % to 4.0 mol % of Na;
42.3 mol % to 47.5 mol % of Zr; and
more than 0 mol % to 6.2 mol % of Ti based on 100 mol % of a total amount of the Pb, the La, the Na, the Zr, and the Ti in the dielectric ceramic.

10. The dielectric ceramic according to claim 9, wherein:
the Na is 0.5 mol % to 4.0 mol %; and
the Ti is 2.5 mol % to 6.2 mol %.

11. The dielectric ceramic according to claim 9, wherein the oxide is 95% by weight or more of the dielectric ceramic.

12. The dielectric ceramic according to claim 9, wherein the oxide is 99% by weight or more of the dielectric ceramic.

13. The dielectric ceramic according to claim 9, wherein the oxide is a perovskite oxide represented by ABO₃.

14. The dielectric ceramic according to claim 13, wherein the perovskite oxide has a structure in which a Pb ion is positioned at the A site, a Ti ion and a Zr ion are positioned at the B site, and an La ion and an Na ion occupy a part of the A site.

15. The dielectric ceramic according to claim 9, wherein the dielectric ceramic is represented by:
(Pbₐ₂La_{b2}Na_{c2})₁₊ₘ₂(Zr_{d2}Tiₑ₂)O₃, where
0.80≤a2≤0.94,
0.05≤b2≤0.13,
0<c2≤0.08,
0.87≤d2<1.00,
0<e2≤0.13,
a2+b2+c2=1, d2+e2=1, and −0.07≤m2≤0.07.

16. The dielectric ceramic according to claim 15, wherein
0.01≤c2≤0.08,
0.87≤d2≤0.95, and
0.05≤e2≤0.13.

17. The dielectric ceramic according to claim 16, wherein
0.87≤d2≤0.93, and
0.07≤e2≤0.13.

18. The dielectric ceramic according to claim 15, wherein
0.91≤d2<1.00, and
0<e2≤0.09.

19. An electronic component comprising:
a ceramic element including the dielectric ceramic according to claim 9; and
an electrode on the ceramic element.
